(19) United States
(12) Patent Application Publication
(10) Pub. No.: US 2025/0049065 A1
(43) Pub. Date: Feb. 13, 2025

(54) FROZEN DISPENSING MACHINE HEAT TREATMENT SYSTEM AND METHOD

(71) Applicant: TAYLOR COMMERCIAL FOODSERVICE, LLC, Rockton, IL (US)

(72) Inventors: Steven M. WADLE, Beloit, WI (US); James J. MINARD, Roscoe, IL (US)

(21) Appl. No.: 18/926,072

(22) Filed: Oct. 24, 2024

Related U.S. Application Data
(63) Continuation of application No. 18/111,727, filed on Feb. 20, 2023.
Application No. 18/111,727 is a continuation of application No. 16/091,301, filed on Oct. 4, 2018, now abandoned.
(60) Provisional application No. 62/319,422, filed on Apr. 7, 2016.

(51) Int. Cl. A23G 9/30; A23G 9/28; A23L 3/16

(52) U.S. Cl. CPC A23G 9/305; A23G 9/28; A23G 9/281; A23G 9/30; A23L 3/16; A23V 2002/00

(57) ABSTRACT

A method of performing a heat treatment cycle on a volume of product in a frozen food dispensing machine includes disconnecting a product storage portion of the machine from a freezing portion and a dispensing portion of the machine, defining a heat treatment circuit including the freezing portion and the dispensing portion of the machine, maintaining a first volume of product at the product storage portion at a product storage temperature and performing a heat treatment cycle on a second volume of product disposed in the heat treatment circuit at a heat treatment temperature greater than the product storage temperature.

### CROSS-REFERENCE TO RELATED APPLICATIONS

This application is a continuation of U.S. Nonprovisional application Ser. No. 18/111,727, filed on Feb. 20, 2023, which is a continuation of U.S. Nonprovisional application Ser. No. 16/091,301, with a nationalization date of Oct. 4, 2018, which is a US national phase application under 35 USC § 371 of PCT Application No. PCT/US2017/025360, filed on Mar. 31, 2017, which claimed priority from U.S. Provisional Application No. 62/319,422 filed on Apr. 7, 2016, the entirety of which are each hereby fully incorporated by reference herein.

### BACKGROUND

The subject matter disclosed herein relates to frozen food product dispensing machines. More specifically, the present disclosure relates to heat treatment of frozen food product dispensing machines.

In a typical frozen food dispensing machine, such as a frozen dessert dispenser, product or product mix, typically in a liquid state is delivered to the machine. The bag is opened, and the product or mix is emptied from the bag into a storage hopper portion of the machine. The hopper stores the product and refrigerates it, without freezing the product. To dispense, the product is flowed from the hopper into a freezing cylinder where it is frozen, then to a dispensing portion where it is dispensed as frozen food. To ensure clean or sanitary conditions of the dispensing machine and the frozen food itself, the machine is either emptied, cleaned and sanitized or sanitized using a heat-treating cycle at a selected interval, usually once per day. Emptying the machine results in considerable waste of product, which is disposed from the machine. The possibility exists of potential contamination or spillage of product emptied into the hopper once the sanitizing steps are complete.

Two methodologies currently are utilized to ensure that the dispensed product is safe to consume. The first includes a periodic heat treatment of the entire machine, including product storage bins, transport lines, freezing cylinder and dispensing portion, including the product therein. This is a large volume of material and product to bring up to heat treatment temperature, which subsequently takes a considerable amount of time and energy. The other method involves periodically draining the entire machine and manually cleaning it. This is labor and time intensive, and also costly since the drained product is discarded.

### SUMMARY

In one embodiment, a method of performing a heat treatment cycle on a volume of product in a frozen food dispensing machine includes disconnecting a product storage portion of the machine from a freezing portion and a dispensing portion of the machine, defining a heat treatment circuit including the freezing portion and the dispensing portion of the machine, maintaining a first volume of product at the product storage portion at a product storage temperature and performing a heat treatment cycle on a second volume of product disposed in the heat treatment circuit at a heat treatment temperature greater than the product storage temperature.

Additionally or alternatively, in this or other embodiments disconnecting the product storage portion of the machine includes disconnecting a probe from a fitment of the product storage portion.

Additionally or alternatively, in this or other embodiments defining the heat treatment circuit includes connecting the probe to a recirculation line at a recirculation port, the recirculation line extending from the recirculation port to one of the freezing portion or the dispensing portion completing the heat treatment circuit.

Additionally or alternatively, in this or other embodiments the heat treatment cycle includes raising a temperature of the second volume of product to at least the heat treatment temperature within a first time duration, holding the second volume of product at the heat treatment temperature for at least a second time duration, and cooling the second volume of product to an operational temperature within a third time duration.

Additionally or alternatively, in this or other embodiments the first time duration is about ninety minutes.

Additionally or alternatively, in this or other embodiments the second time duration is about 30 minutes.

Additionally or alternatively, in this or other embodiments the heat treatment temperature is about 150 degrees Fahrenheit.

Additionally or alternatively, in this or other embodiments the product storage portion of the machine is reconnected to the freezing portion and the dispensing portion of the machine upon completion of the heat treatment cycle.

In another embodiment, a frozen food dispensing machine includes a product storage portion including a first volume of product, a freezing portion operably connected to the product storage portion, a dispensing portion operably connected to the freezing portion to dispense a frozen food product, a recirculation line operably connectable to one or more of the freezing portion or the dispensing portion, and a product delivery line operably connected to the freezing portion. The product delivery line is selectably connectable to the product storage portion for dispensing operations of the frozen food dispensing machine or to the recirculation line to define a heat treatment circuit for periodic heat treatment of a second volume of product disposed at the heat treatment circuit. The heat treatment circuit includes the freezing portion and the dispensing portion and omits the product storage portion.

Additionally or alternatively, in this or other embodiments the product storage portion includes a fitment for connection to the product delivery line.

Additionally or alternatively, in this or other embodiments the product delivery line includes a probe for connecting to the product storage, the probe containing a one-way valve to prevent product flow from the product delivery line into the product storage portion.

Additionally or alternatively, in this or other embodiments the first volume of product is contained in one or more bins, bottles or bags.

Additionally or alternatively, in this or other embodiments the first volume of product is maintained at an operational temperature of the frozen food dispensing machine.

Additionally or alternatively, in this or other embodiments the first volume of product is stored in a refrigerated cabinet.

Additionally or alternatively, in this or other embodiments the heat treatment includes raising a temperature of the second volume of product to a heat treatment temperature within a first time duration, holding the second volume of product at the heat treatment temperature for at least a second time duration, and cooling the second volume of product to the operational temperature within a third time duration.

In yet another embodiment, a frozen food dispensing machine includes a first zone including a product storage portion, a second zone operably connected to the first zone for flowing product from the first zone, and a third zone configured to receive a flow of product from the second zone, freeze the flow of product, and dispense the flow of product. The second zone and the third zone are isolatable from the first zone.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is schematic view of an embodiment of a frozen food dispensing machine configured for dispensing operation;

FIG. 2 is a schematic view of an embodiment of a frozen food dispensing machine configured for heat treatment operation;

FIG. 3 is another schematic view of an embodiment of a frozen food dispensing machine;

FIG. 4 is a perspective view of an embodiment of a freezing cylinder of a frozen food dispensing machine;

FIG. 5 is a schematic view of a conductive heater location in an embodiment of a frozen food dispensing machine;

FIG. 6 is a cross-sectional view of an embodiment of a freezing cylinder of a frozen food dispensing machine.

### DETAILED DESCRIPTION

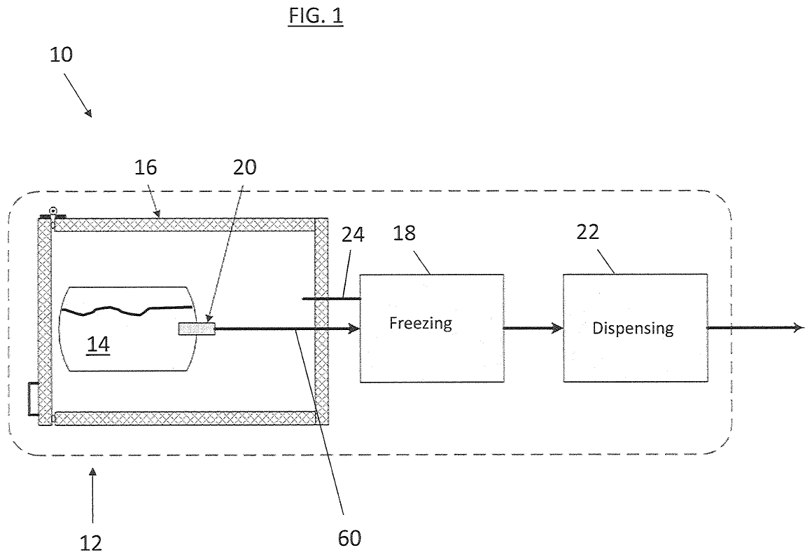

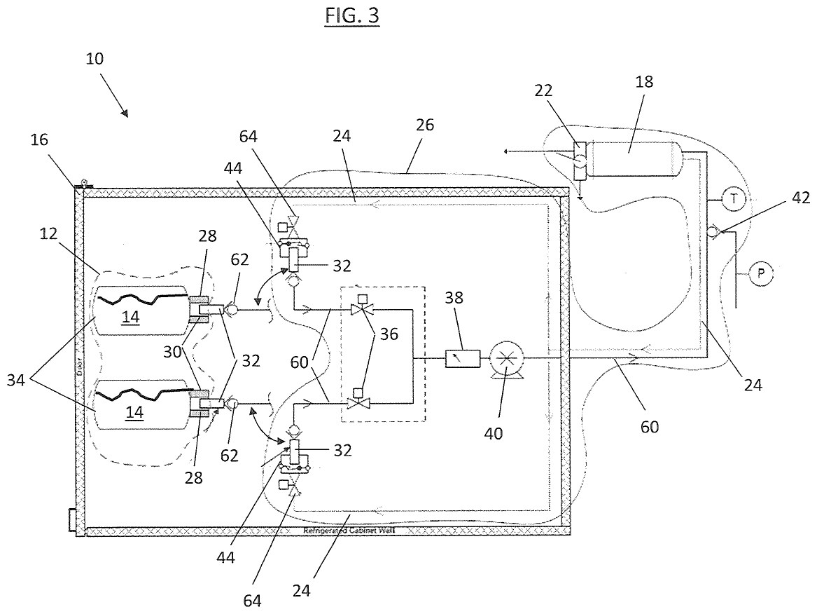

In FIG. 1 is shown a schematic of a frozen food dispensing machine (hereinafter “machine”) 10 configured for dispensing operation. The machine 10 includes a product storage section 12, where a volume of liquid product 14 is stored for use by the machine 10. The product storage section 12 includes a storage compartment 16, which in some embodiments is refrigerated to about 41 degrees Fahrenheit or other temperature, while in other embodiments the storage compartment 16 is maintained at about ambient temperature. The volume of product 14 is stored in a container, for example, a bag or a bin and is connected to a freezing cylinder 18 via a fitting 20. Shown best in FIG. 3, a product bag 34 is equipped with a fitment 28 that includes a self-closing seal 30 that prevents flow from the bag 34 unless the fitting 20 is connected to the product bag 34. Referring again to FIG. 1, the liquid product 14 is frozen at the freezing cylinder 18 and conveyed to a dispensing portion 22 for dispensing of frozen product into a container, such as a cup or a cone (not shown).

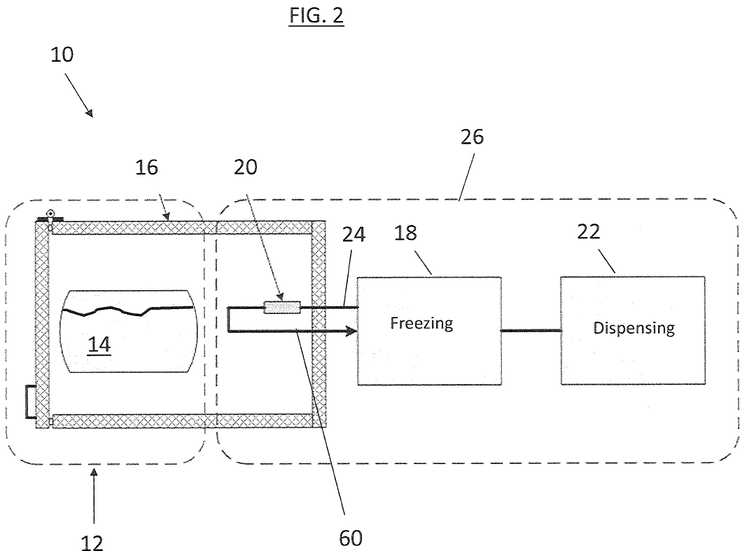

Referring now to FIG. 2, to ensure the product is safe for consumption, the machine 10 is periodically cycled through a heat treatment operation. The machine 10 utilizes a unique method to reduce the heat treated volume and thus reduce the time and energy utilized for a heat treatment cycle. Before initiating heat treatment, the fitting is disconnected from the product 14 and connected to a recirculation line 24. The product 14 is isolated from the remainder of the machine 10, and connecting the fitting 20 to the recirculation line 24 closes a heat treat circuit 26 with the freezing cylinder 18 and the dispensing portion 22. In some embodiments, the recirculation line 24 is connected to the freezing cylinder 18, while in other embodiments the recirculation line is connected to the dispensing portion 22. In addition, the recirculation line 24 may be permanently connected to the machine 10, or it may be a separate part connected to the machine 10, for heat treatment.

The product in the heat treat circuit 26 is then heated up to a heat treat temperature, in some embodiments about 150 degrees Fahrenheit, for a selected duration of time to accomplish the heat treatment. In some embodiments, the product is heated to the heat treatment temperature within 90 minutes or less, and will hold at the heat treat temperature for at least 30 minutes. After heat treatment is completed, the product in the heat treat circuit is then cooled to operating temperature and the fitting 20 is disconnected from the recirculation line 24 and reconnected to the product 14 for resumption of normal operation of the machine 10. Embodiments of this system and method will be described in more detail below. To heat the product in the heat treat circuit 26, a heater disposed at, for example, the freezing cylinder 18 (discussed below) may be utilized. Alternatively, the heater may be located at another portion of the heat treat circuit 26, or the heat treat circuit may be heated by, for example, a heat wrap around lines of the heat treat circuit 26. In still other embodiments, the heat treat circuit 26 may direct product through a heater box (not shown) to heat the product.

Referring now to FIG. 3, another exemplary embodiment is shown. The machine 10 includes a storage compartment 16 that includes product 14 stored in two product bags 34. As stated above, the product 14 may alternatively be stored in a bin, bottle or other container. Further, while two product bags 34 are illustrated, other quantities may be utilized depending on capacity and use of the storage compartment 16. For example, other embodiments may include 1, 3, 4 or 6 or more product bags 34. In some embodiments, each product bag 34 has a capacity of about 10 liters, but one skilled in the art will readily appreciate that other sizes may be utilized. The probe 32 includes a one-way or check valve 62 that prevents inflow of material or contaminants into the product bag 14. The probe 32 is configured such that product 14 flow is in one direction only, out of product bag 34. The product bag 34 is equipped with fitment 28 that includes self-closing seal 30 that prevents flow from the product bag 34 unless the probe 32 is inserted into the product bag 34.

During normal dispensing operation of the machine 10, a probe 32 is connected to the fitment 28 to allow product 14 to flow from the product bag 34. The probe 32 is connected to, or is an end portion of, a product delivery line 60. The product 14 flows through the probe 32, along the product delivery line 60, and in some embodiments through a changeover valve 36, and then in some embodiments past a switch 38 to detect flow from two or more product bags 34. The product 14 is urged from the product bag 34 by a pump 40 located downstream of the switch 38. Downstream of the pump 40, the product 14 flow exits the storage compartment 16. While in the embodiment shown, the pump 40 is located inside the refrigerated compartment, in other embodiments the pump 40 may be located outside of the storage compartment 16.

From the pump 40, the product 14 flow continues along the product delivery line 60 toward the freezing cylinder 18. Before reaching the freezing cylinder 18, air is injected into the product 14 flow via an air injection valve 42. Once frozen at the freezing cylinder 18, the product 14 is dispensed at the dispenser 22. Air may be injected at any location into the product at any location between the probe 32 and the dispensing portion 22.

Periodically, in some embodiments once per day, the machine 10 undergoes the heat treat cycle. To configure the machine 10 for the heat treat cycle, the probes 32 are disconnected from the fitments 28. Each probe 32 and a corresponding recirculation port 44 of the recirculation line 24 may be sanitized, then each probe 32 is then installed to the corresponding recirculation port 44 of the recirculation line 24. Once the probes 32 are installed to the recirculation ports 44, the valve coupling 64 opens, one or more of the changeover valves 36 open, and the pump 40 is started to circulate product 14 through a heat treat circuit 26, defined from the pump 40 through the product delivery line 60, through the freezing cylinder 18, from the freezing cylinder 18 through the recirculation line 24 and through the recirculation port 44/probe 32 interface and back to the pump 40.

To perform the heat treat, the product 14 flowing through the heat treat circuit 26 is heated from the operational temperature of 41 degrees Fahrenheit to the heat treat temperature of 150 degrees Fahrenheit or higher, within 90 minutes or less, and will hold at the heat treat temperature for at least 30 minutes. Once the heating and hold portions of the heat treat cycle, the product flowing through the heat treat circuit 26 is cooled from the heat treat temperature back to the operational temperature in a time span of 120 minutes or less. In some embodiments, the cooling is aided by activating the freezing cylinder 18.

To return the machine 10 to normal operation once the product 14 is cooled, the pump 40 is stopped. The probes 32 are disconnected from the recirculation ports 44, the valve coupling 64 closes, and both the probes 32 and the fitments 28 are sanitized, and each probe 32 is then connected to a corresponding fitment 28.

Disconnecting the probes 32 from the fitments 28 prior to the heat treat operation isolates the product bags 34 from the heat treat circuit 26 thus greatly reducing a volume of product 14 that is heat treated, and as a consequence reducing the time and energy necessary for the heat and hold portions of the heat treat cycle. Because the product 14 is stored in the product bag 34 with the check valve 62 preventing flow from the probe 32 into the product bag 34, there is no need to heat treat the product 14 inside the product bag 34.

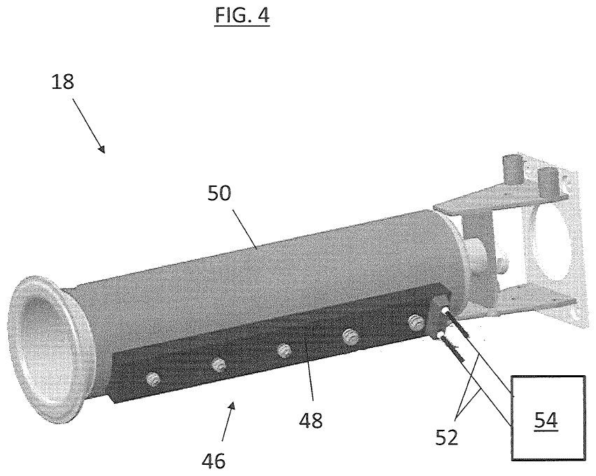

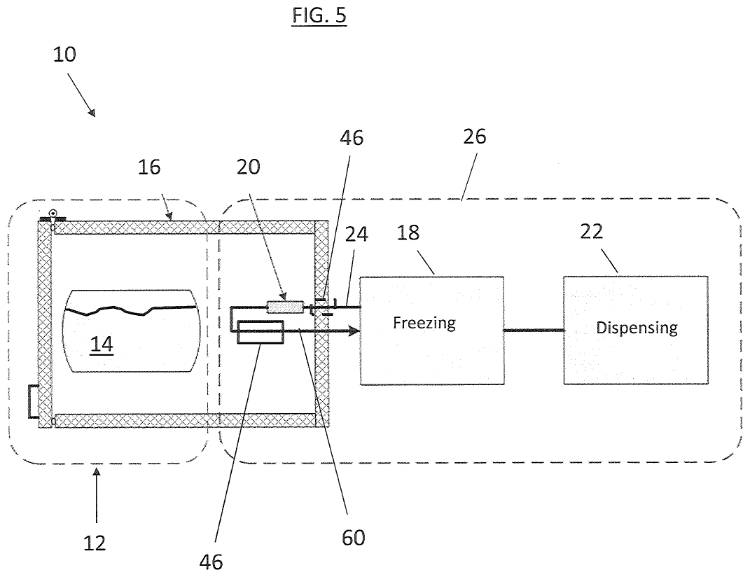

Referring now to FIG. 4, the product 14 flow in the heat treat circuit 26 is heated by a heater located at, for example, the freezing cylinder 18. In some embodiments, the heater is a conductive heater 46 fixed to an outer wall of the freezing cylinder 18. The conductive heater 46 utilizes a heating element 48 in contact with a freezing cylinder vessel 50, to conductively heat the freezing cylinder vessel 50 and thus heat the product 14 flowing through the freezing cylinder 18. In some embodiment a thermal mastic or graphite gasket (not shown) is located between the heating element 48 and the freezing cylinder vessel 50. The heating element 48 is connected to electrical leads 52, and when a voltage is applied to the electrical leads 52 from a voltage source 54, the heating element 48 heats, thus heating the freezing cylinder vessel 50. In other embodiments, such as shown in FIG. 5, the conductive heater 46 may be disposed at other locations of the machine 10, such as at the product delivery line 60, the recirculation line 24, or at an entrance or exit of the freezing cylinder 18.

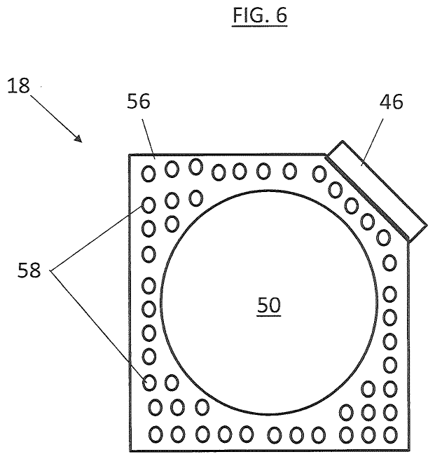

In some embodiments, such as shown in FIG. 6, the conductive heater 46 is used in conjunction with a heat exchanger, for example, a micro-channel heat exchanger (MCHX) 56 wrapped at least partially around the freezing cylinder vessel 50. The MCHX 56 includes a plurality of micro-channels 58 in which a heat transfer medium is located. When energized, the heating element 46 heats the MCHX 56, which in turn heats the freezing cylinder vessel 50. Utilizing the MCHX 56 in conjunction with the conductive heater 46 has the capability of distributing the heating effects of the conductive heater 46 over an increased circumferential area of the freezing cylinder vessel 50 to more quickly and more evenly heat the product 14 flowing through the freezing cylinder vessel 50 during the heat treatment cycle. In some embodiments, the conductive heater 46 heats the freezing cylinder vessel 50 to a freezing cylinder temperature greater than the heat treatment temperature prior to circulating the product through the heat treat circuit 26. In some embodiments, the freezing cylinder temperature is about 175 degrees Fahrenheit. This allows the product flowing therethrough to be quickly heated to the heat treatment temperature. While in some embodiments, the conductive heater 46 is located at a heat exchanger body of the MCHX 56, in other embodiments, the conductive heater 46 is located at one or more of a MCHX supply line or an MCHX return line.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate in spirit and/or scope. Additionally, while various embodiments have been described, it is to be understood that aspects of the present disclosure may include only some of the described embodiments. Accordingly, the present disclosure is not to be seen as limited by the foregoing description, but is only limited by the scope of the appended claims.

The specification can be referenced with respect to the Representative Paragraphs provided below:
Representative Paragraph 1: A method of performing a heat treatment cycle on a volume of product in a frozen food dispensing machine, comprising:
disconnecting a product storage portion of the machine from a freezing portion and a dispensing portion of the machine;
defining a heat treatment circuit including the freezing portion and the dispensing portion of the machine;
maintaining a first volume of product at the product storage portion at a product storage temperature; and
performing a heat treatment cycle on a second volume of product disposed in the heat treatment circuit at a heat treatment temperature greater than the product storage temperature.
Representative Paragraph 2: The method of Representative Paragraph 1, wherein disconnecting the product storage portion of the machine includes disconnecting a probe from a fitment of the product storage portion.
Representative Paragraph 3: The method of Representative Paragraph 2, wherein defining the heat treatment circuit includes connecting the probe to a recirculation line at a recirculation port, the recirculation line extending from the recirculation port to one of the freezing portion or the dispensing portion completing the heat treatment circuit.
Representative Paragraph 4: The method of any of Representative Paragraphs 1-3, wherein the heat treatment cycle includes:
raising a temperature of the second volume of product to at least the heat treatment temperature within a first time duration;
holding the second volume of product at the heat treatment temperature for at least a second time duration; and
cooling the second volume of product to an operational temperature within a third time duration.
Representative Paragraph 5: The method of Representative Paragraph 4, wherein the first time duration is about ninety minutes.
Representative Paragraph 6: The method of Representative Paragraph 4 or 5, wherein the second time duration is about 30 minutes.
Representative Paragraph 7: The method of any of Representative Paragraphs 4-6, wherein the heat treatment temperature is about 150 degrees Fahrenheit.
Representative Paragraph 8: The method of any of Representative Paragraphs 1-7, further comprising reconnecting the product storage portion of the machine to the freezing portion and the dispensing portion of the machine upon completion of the heat treatment cycle.
Representative Paragraph 9: A frozen food dispensing machine comprising:
a product storage portion including a first volume of product;
a freezing portion operably connected to the product storage portion;
a dispensing portion operably connected to the freezing portion to dispense a frozen food product;
a recirculation line operably connectable to one or more of the freezing portion or the dispensing portion; and
a product delivery line operably connected to the freezing portion, the product delivery line selectably connectable to the product storage portion for dispensing operations of the frozen food dispensing machine or to the recirculation line to define a heat treatment circuit for periodic heat treatment of a second volume of product disposed at the heat treatment circuit, the heat treatment circuit including the freezing portion and the dispensing portion and omitting the product storage portion.
Representative Paragraph 10: The frozen food dispensing machine of Representative Paragraph 9, wherein the product storage portion includes a fitment for connection to the product delivery line.
Representative Paragraph 11: The frozen food dispensing machine of Representative Paragraph 9 or 10, wherein the product delivery line includes a probe for connecting to the product storage, the probe containing a one-way valve to prevent product flow from the product delivery line into the product storage portion.
Representative Paragraph 12: The frozen food dispensing machine of any of Representative Paragraphs 9-11, wherein the first volume of product is contained in one or more bins, bottles or bags.
Representative Paragraph 13: The frozen food dispensing machine of any of Representative Paragraphs 9-12, wherein the first volume of product is maintained at an operational temperature of the frozen food dispensing machine.
Representative Paragraph 14: The frozen food dispensing machine of any of Representative Paragraphs 9-13, wherein the first volume of product is stored in a refrigerated cabinet.
Representative Paragraph 15: The frozen food dispensing machine of any of Representative Paragraphs 9-14, wherein the heat treatment includes:
raising a temperature of the second volume of product to a heat treatment temperature within a first time duration;
holding the second volume of product at the heat treatment temperature for at least a second time duration; and
cooling the second volume of product to the operational temperature within a third time duration.
Representative Paragraph 16: A frozen food dispensing machine comprising:
   a first zone including a product storage portion;
   a second zone operably connected to the first zone for flowing product from the first zone; and
a third zone configured to:
   receive a flow of product from the second zone;
   freeze the flow of product; and
   dispense the flow of product;
wherein the second zone and the third zone are isolatable from the first zone.

1. A method of performing a heat treatment cycle on a volume of product in a frozen food dispensing machine, comprising:
disconnecting a product storage portion of the frozen food dispensing machine from a freezing portion of the frozen food dispensing machine and a dispensing portion of the frozen food dispensing machine, wherein the product storage portion is refrigerated inside a storage compartment of the frozen food dispensing machine, and wherein a product delivery line is provided that is operably connected to the freezing portion, and in normal operation of the frozen food dispensing machine the product delivery line is connected to the product storage portion;
defining a heat treatment circuit including the freezing portion and the dispensing portion of the frozen food dispensing machine;
maintaining, while the product storage portion of the machine is disconnected from the freezing portion of the frozen food dispensing machine and the dispensing portion of the frozen food dispensing machine, the first volume of product at a refrigerated temperature;
connecting a recirculation line with the product delivery line in the heat treatment circuit; and
performing a heat treatment cycle on a second volume of product disposed in the heat treatment circuit at a heat treatment temperature greater than the refrigerated temperature.

2. The method of claim 1, wherein the product delivery line includes a probe for connecting to a fitment of the product storage portion and for connecting to the recirculation line.

3. The method of claim 2, wherein product flows through the probe and a changeover valve along the product delivery line.

4. The method of claim 2, wherein disconnecting the product storage portion of the frozen food dispensing machine includes disconnecting the probe from the fitment of the product storage portion.

5. The method of claim 2, wherein defining the heat treatment circuit includes connecting the probe to the recirculation line at a recirculation port, the recirculation line extending from the recirculation port to one of the freezing portion or the dispensing portion completing the heat treatment circuit.

6. The method of claim 1, wherein the heat treatment cycle includes:
raising a temperature of the second volume of product to at least the heat treatment temperature within a first time duration;
holding the second volume of product at the heat treatment temperature for at least a second time duration; and
cooling the second volume of product to an operational temperature within a third time duration.

7. The method of claim 1, further comprising reconnecting the product storage portion of the frozen food dispensing machine to the freezing portion and the dispensing portion of the frozen food dispensing machine upon completion of the heat treatment cycle.

8. A frozen food dispensing machine comprising:
a storage compartment that is refrigerated;
a product storage portion having a first volume of product, the product storage portion being positioned within the storage compartment of the frozen food dispensing machine such that the first volume of product is refrigerated inside of the frozen food dispensing machine;
a freezing portion operably connected to the product storage portion, the freezing portion comprising a freezing cylinder;
a dispensing portion connected to the freezing portion to dispense a frozen food product; a recirculation line operably connected to one or more of the freezing portion or the
dispensing portion; and
a product delivery line operably connected to the freezing portion, the product delivery line selectably connectable to the product storage portion for dispensing operations of the frozen food dispensing machine or to the recirculation line to define a heat treatment circuit for periodic heat treatment of a second volume of product disposed at the heat treatment circuit, the heat treatment circuit including the freezing portion and the dispensing portion and omitting the product storage portion, wherein, while disconnected from the freezing portion of the frozen food dispensing machine and the dispensing portion of the frozen food dispensing machine, the product storage portion of the frozen food dispensing machine is maintained at a refrigerated temperature within the storage compartment of the frozen food dispensing machine.

9. The frozen food dispensing machine of claim 8, wherein the product delivery line includes a probe for selectively connecting to a fitment of the product storage portion and for connecting to the recirculation line.

10. The frozen food dispensing machine of claim 9, wherein the probe connects to one of the fitment of the product storage portion or the recirculation line at a time.

11. The frozen food dispensing machine of claim 9, wherein the probe contains a one-way valve to prevent product flow from the product delivery line into the product storage portion when the probe is connected to the product storage portion.

12. The frozen food dispensing machine of claim 9, wherein the fitment includes a self-closing seal that prevents flow therethrough unless the probe is inserted into the fitment.

13. The frozen food dispensing machine of claim 8, further comprising a conductive heater fixed with respect to the freezing cylinder such that a heating element of the conductive heater is in contact with the freezing cylinder.

14. The frozen food dispensing machine of claim 9, further comprising a changeover valve along the product delivery line, wherein product flows through the probe and the changeover valve during dispensing operations of the frozen food dispensing machine and during the heat treatment circuit.

15. The frozen food dispensing machine of claim 8, wherein the first volume of product is contained in one or more bins, bottles or bags, wherein product flows past a switch along the product delivery line to detect flow from the one or more bins, bottles or bags.

16. A frozen food dispensing machine comprising:
a storage compartment that is refrigerated;
a product storage portion having a first volume of product, the product storage portion being positioned within the storage compartment of the frozen food dispensing machine such that the first volume of product is refrigerated inside of the frozen food dispensing machine;
a freezing portion operably connected to the product storage portion, the freezing portion comprising a freezing cylinder;
a dispensing portion connected to the freezing portion to dispense a frozen food product; a recirculation line operably connected to one or more of the freezing portion or the
dispensing portion;
a product delivery line operably connected to the freezing portion, wherein the product delivery line includes a probe for selectively connecting to a fitment of the product storage portion for dispensing operations of the frozen food dispensing machine or to the recirculation line to define a heat treatment circuit for periodic heat treatment of a second volume of product disposed at the heat treatment circuit, the heat treatment circuit including the freezing portion and the dispensing portion and omitting the product storage portion, wherein, while disconnected from the freezing portion of the frozen food dispensing machine and the dispensing portion of the frozen food dispensing machine, the product storage portion of the frozen food dispensing machine is maintained at a refrigerated temperature within the storage compartment of the frozen food dispensing machine;
a changeover valve along the product delivery line, wherein product flows through the probe and the changeover valve during dispensing operations of the frozen food dispensing machine and during the heat treatment circuit; and
a heat exchanger with a plurality of channels is wrapped at least partially around the freezing cylinder, and a conductive heater that is positioned to provide heat to the heat exchanger, wherein during operation of the heat exchanger, heat generated by the conductive heater is provided to the freezing vessel and the product disposed therein.

17. The frozen food dispensing machine of claim 16, wherein the conductive heater is located at a body of the heat exchanger.

18. The frozen food dispensing machine of claim 16, wherein the conductive heater is located in contact with a supply line or a return line to the heat exchanger.

19. The frozen food dispensing machine of claim 16, wherein the first volume of product is contained in one or more bins, bottles or bags, wherein product flows past a switch along the product delivery line to detect flow from the one or more bins, bottles or bags.

20. The frozen food dispensing machine of claim 16, wherein the probe contains a one-way valve to prevent product flow from the product delivery line into the product storage portion when the probe is connected to the product storage portion.
